(19) United States
(12) Patent Application Publication
(10) Pub. No.: US 2024/0269966 A1
(43) Pub. Date: Aug. 15, 2024

(54) ADHESIVE FORMULATION FOR PRODUCING PRESSED MATERIAL MOLDED BODIES

(71) Applicant: Lignom Holding S.à r.l., Luxemburg (LU)

(72) Inventor: Herbert MIKOWITSCH, Moedling (AT)

(73) Assignee: Lignom Holding S.à r.l., Luxemburg (LU)

(21) Appl. No.: 18/022,047

(22) PCT Filed: Aug. 17, 2021
(86) PCT No.: PCT/EP2021/072780

§ 371 Date: Feb. 17, 2023

(30) Foreign Application Priority Data
Aug. 18, 2020 (AT) A 50696/2020

(51) Int. Cl. B32B 21/02; B32B 7/12; B32B 21/13; B32B 37/12

(52) U.S. Cl. CPC B32B 21/02; B32B 7/12; B32B 21/13; B32B 37/1284; B32B 2037/1253; B32B 2260/025; B32B 2260/046; B32B 2305/076; B32B 2305/72; B32B 2329/04; B32B 2333/08

(57) ABSTRACT

A chemically curable, aqueous adhesive formulation for producing pressed material molded bodies, in particular pressed material plates includes 35 wt. % to 85 wt. % of an aqueous phase of a reactive resin functionalized with functional hydroxyl groups or a mixture of reactive resins functionalized with functional hydroxyl groups. The aqueous adhesive formulation further includes 12 wt. % to 25 wt. % of an aqueous phase of a urea resin crosslinking agent, which is a reaction product formed by a urea and a multifunctional aldehyde. Additionally, the adhesive formulation includes 0.1 wt. % to 4 wt. % of an acid catalyst. Additionally, a method for producing pressed material molded bodies, in particular pressed material plates, using uses such an adhesive formulation.

The invention relates to a chemically curably, aqueous adhesive formulation for producing pressed material molded bodies, in particular pressed material plates, as well as a method for producing pressed material molded bodies, in particular pressed material plates, by means of continuous or discontinuous pressing of mixtures of the adhesive formulation and chip material and/or fiber material or by pressing layers of the adhesive formulation and chip material plates and/or fiber material plates.

The term pressed material molded body is very generally understood to mean a molded body which is molded to form the pressed material molded body by means of joining materials comprising chip or fiber material by curing an admixed adhesive formulation, by applying a pressure force, and possibly by heating. The by far most common application of such molded bodies is in the form of plates. The term pressed material molded body thus also includes, for example, chipboards, in particular wafer boards (also referred to as oriented strand boards; OSB), medium-density (wood) fiberboards (so-called MDF plates), high-density (wood) fiberboards (so-called HDF plates), but also layered and/or laminated plate structures, such as laminated veneer lumber plates.

Hence, the term chip material and/or fiber material comprises very generally materials having fibers, such as wood and/or cellulose fibers, including fibers from recycled paper, other recycling material like sawmill waste or recycled lumber, other naturally occurring fibers, such as straw, bamboo, etc., but also synthetic fibers, for example polyester fibers. Of course, the term chip material and/or fiber material also includes mixtures of fibers of different types. In this regard, the chip material and/or fiber material may absolutely have different shapes and degrees of comminution. Thus, the chip material and/or fiber material may already be present fully formed, that is as fiber composite bodies, like, for example, in the aforementioned veneer layer plates. The chip material and/or fiber material may, however, also be provisioned more or less loosely, with different grinding degrees, for example with a relatively low grinding degree as so-called chips, like in the aforementioned chipboards or OSB plates, or also in loose form with a relatively high grinding degree, such as, for example, as digested, so-called wood flour, as, for example, in the aforementioned MDF and HDF plates.

Regardless of the type of the chip material and/or fiber material, the (different) methods for producing pressed material molded bodies have in common that a fiber material provided with an adhesive formulation is pressed into a shape using pressure and possibly heat.

Adhesive formulations for these mentioned applications are generally known, wherein these known adhesive formulations, however, have to be adapted depending on the type of the molded body and/or the plate to be produced, and thus, depending on the respective procedure to be used. To some extent, different procedures even use adhesive formulations that are chemically entirely different. For example, the production of so-called fiberboards predominantly uses urea-formaldehyde resins, so-called UF resins, and, in minor quantities, also isocyanate-based resins, whereas mainly phenol resins are used for joining and/or gluing veneer layers together. This necessity of adapting an adhesive formulation to a particular procedure and/or a product, may have a disadvantageous effect on the efficiency.

The adhesive formulations mainly used nowadays in methods for producing pressed material molded bodies have in common that pollutants are released primarily during the curing process. Examples for such pollutants are, inter alia, formaldehyde and volatile components and decomposition products of isocyanate-based formulations. Although efforts to at least reduce the amount of releasable pollutants in the predominantly used adhesive formulations have already been made, such formulations low in pollutants often entail other problems, in particular in terms of process technology.

For example, when producing pressed material molded pieces, a sufficiently short processing time must be given, in order to be able to perform a method economically. Thus, in the methods mainly used nowadays, the pressing of chip material and/or fiber material and adhesive at high temperatures is carried out. The production of chip and/or fiber plates is typically carried out at temperatures of 200° C. to 250° C. These high temperatures are necessary, mostly in order to also achieve as complete a curing in the core of the pressing mixtures as possible, as a press cake of chip material and/or fiber material, for example, is heated from the sides, and the heat has to be conducted into the inner core. However, with the adhesive formulations, including the variants low in pollutants, used nowadays, these high temperatures often lead to damage to a molded body, for example a tearing of the molded body, and may thus cause a high scrap rate.

The object of the invention was to overcome the shortcomings of the prior art and to provide an adhesive formulation, by means of which as process-safe a production of pressed material bodies as possible while avoiding great scrap rates as well as a low-pollutant procedure can be obtained, and which simultaneously can be used as universally as possible in different production methods for pressed material molded bodies. Moreover, it was the object of the invention to provide a method for producing pressed material molded bodies using such an adhesive formulation.

This object is achieved, on the one hand, by a chemically curably, aqueous adhesive formulation for producing pressed material molded bodies, in particular pressed material plates, by means of continuous or discontinuous pressing of mixtures of the adhesive formulation and chip material and/or fiber material or by pressing layers of the adhesive formulation and fiber material plates.

This chemically curable, aqueous adhesive formulation comprises at least one chemically curable reactive resin and at least one crosslinking agent and/or curing agent for the reactive resin.

The chemically curable, aqueous adhesive formulation comprises in particular 35 wt. % to 85 wt. % of an aqueous phase of a reactive resin functionalized with hydroxyl groups or a mixture of reactive resins functionalized with functional hydroxyl groups with a resin content of 30 wt. % to 65 wt. %, as well as 12 wt. % to 25 wt. % of an aqueous phase of a urea resin crosslinking agent, which is a reaction product formed of urea and a multifunctional aldehyde, with a resin content of 30 wt. % to 65 wt. % and 0.1 wt. % to 4 wt. % of an acid catalyst with a pKa value of 2 or less.

Preferably, the chemically curable aqueous adhesive formulation may comprise 50 wt. % to 80 wt. % of the aqueous phase of the reactive resin functionalized with hydroxyl groups or the mixture of reactive resins functionalized with functional hydroxyl groups. Preferably, the resin content of this aqueous phase may amount to 35 wt. % to 60 wt. %.

Preferably, the adhesive formulation may comprise 14 wt. % to 22 wt. % of the aqueous phase of the urea resin crosslinking agent. Preferably, a resin content of this aqueous phase may amount to 35 wt. % to 60 wt. %.

In particular, the adhesive formulation may comprise 0.5 wt. % to 3.5 wt. % of the acid catalyst.

An aqueous phase is understood to mean, depending on the type of the reactive substances used, that is depending on the reactive resin and crosslinking agent/curing agent, an aqueous dispersion and/or an aqueous suspension and/or an aqueous emulsion and/or an aqueous solution of said reactive substances. The remainder in wt. %, that is the balance adding up to 100 wt. % of an aqueous phase may, in this regard, be formed at least mainly by water. The aqueous phases, however, may also have further constituents, such as, for example, dispersion aids and/or suspension aids and/or stabilizers, emulsifiers, defoamers and the like.

Moreover, the adhesive formulation may also comprise other constituents and/or substances and/or additives, such as pigment(s), aside from the mentioned and/or phases. Examples for preferred additives are explained in more detail in the following. If the adhesive formulation comprises further constituents, in particular additives, the person skilled in the art of course has to adapt the weight proportions of the specified aqueous phases (reactive resin, crosslinking agent) and acid catalyst accordingly.

The adhesive formulation may also be referred to as glue formulation, sizing agent and/or also as paste, as it is common in the technical jargon of the relevant technical field. In particular, the adhesive formulation may be intended for producing chipboards, fiberboards, and laminated plate structures, such as laminated veneer lumber plates.

The adhesive formulation with the given features is characterized in that, on the one hand, it can be used without releasing pollutants. As trials have shown, in case of the indicated adhesive formulation, there is particularly no release of formaldehyde or isocyanate when curing the adhesive formulation during the production of the pressed material molded bodies. Thereby, for example when using fiber material based primarily on wood fibers, the release of formaldehyde can be limited and/or reduced, in comparison to conventional adhesive formulations, at least to that amount which is released by the wood fiber material itself. In further consequence, this means advantages with respect to the emission of pollutants during the production of the pressed material molded bodies and/or plates and thus, for example, a significant improvement of the working conditions.

Surprisingly, it has also shown that the adhesive formulation in the specified composition is universally applicable in the technical field of producing pressed material molded bodies, without needing essential adjustments. Thus, for example chipboard, MDF, HDF, OSB as well as layered plates made of chip material and/or fiber material can be produced by means of the adhesive formulation, and/or the respective production methods can be performed by means of the adhesive formulation.

Additionally, it has been shown that when using the adhesive formulation, a temperature during the pressing operation can be reduced significantly compared to the conventional adhesive formulations according to the prior art. For example, in trials, it was possible to reduce a temperature during the pressing operation to about 160° C. or less when using the adhesive formulation for example in the case of producing MDF plates. This is in comparison to the temperatures of more than 200° C. usually required when using conventional adhesive formulations. Completely generally, this also provides for a reduction of energy costs and thus, also a reduction of production costs.

In this context, the adhesive formulation has also proven advantageous with respect to a scrap-free and/or at least low-scrap production of pressed material molded bodies. Apparently, when using the adhesive formulation, on the one hand, a good heat conduction from the outer regions of, for example, a press cake of chip material and/or fiber material and adhesive formulation is provided, so that, in the course of a pressing operation of such a press cake, sufficiently high core temperatures can be achieved in its core area for as complete a curing as possible. This can be proven by, inter alia, the achievable mechanical properties, such as the mechanical flexural strength and/or transverse tensile strength of molded bodies produced as plates, which properties fall clearly inside and/or above the standardized requirements for a respective plate, for example an MDF or HDF plate. On the other hand, it seems that in the course of a pressing operation, barely any damage occurs, also due to the relatively low temperatures that are required for as complete a curing as possible of the present adhesive formulation, and hence, scrap caused by damage can be prevented.

In an advancement of the adhesive formulation, a hydroxyl active equivalent weight of the aqueous phase of the reactive resin functionalized with hydroxyl groups or the mixture of reactive resins functionalized with functional hydroxyl groups may amount to 200 g/mol to 1500 g/mol.

A hydroxyl active equivalent weight in this range has proven particularly suitable for the curing reaction of the hydroxyl-functionalized reactive resin. Preferably, the aqueous phase of the reactive resin functionalized with functional hydroxyl groups or the mixture of reactive resins functionalized with functional hydroxyl groups may have a hydroxyl active equivalent weight of 500 g/mol to 1300 g/mol.

As is known per se, the term functionalized resin may be understood to generally mean a chemical substance in which the respective functional groups, in the present case, for example, hydroxyl groups of the reactive resin of the reactive resin, are present on an oligomeric or polymeric carrier and/or a hydrocarbon structure in a chemically bonded manner. The type of the carrier may generally be diverse in nature.

Preferably, the reactive resin functionalized with hydroxyl groups or the mixture of reactive resins functionalized with functional hydroxyl groups may be selected from a group consisting of acrylate resins, functionalized styrene acrylate resins, functionalized acrylic acid copolymers, functionalized acrylate urethane copolymers and functionalized (meth)acrylate copolymers.

Depending on the type of resins and/or polymers, functionalized with hydroxyl groups, used, the corresponding aqueous phase may be formed, for example, as an aqueous dispersion, suspension, emulsion, or solution. Macrynal SC 6826 WA 42 and Viacryl SC 6834WA 42 by Allnex, and AC 31 by Alberdingk Boley are mentioned as examples for suitable aqueous phases of reactive resins functionalized with hydroxyl groups.

The product Cymel NF 3030 by Allnex is mentioned as an example for a suitable aqueous phase of a urea resin crosslinking agent and/or curing agent for the hydroxyl-functional reactive resin.

The acid catalyst used may be, for example, sulfonic acids, such as (modified) para-Toluenesulfonic acid and derivatives thereof, a suitable example to be mentioned would be Cycat 4045 by Allnex.

In a preferred embodiment variant, the adhesive formulation may comprise 0.1 wt. % to 20 wt. % of a polyvalent alcohol or multiple polyvalent alcohols.

By using a polyvalent alcohol or multiple polyvalent alcohols in the specified wt. % range, especially a curing of the adhesive formulation that is premature and/or too quick may be effectively avoided or delayed if needed. A polyvalent alcohol has a reaction-delaying effect in the specified reactive resin(s) and/or curing agent(s)/crosslinking agent(s) of the adhesive formulation. Thus, the necessary mixing with the chip material and/or fiber material and/or the coating of plates comprising chip material and/or fiber material can be performed without running a great risk of too quick of a curing process. This feature is sensible especially in procedures in which, for example, a mixing of the adhesive formulation with the chip material and/or fiber material is carried out at an increased temperature, for example in a so-called blowline. It has proven particularly useful if the adhesive formulation comprises 1 wt. % to 10 wt. % of a polyvalent alcohol or multiple polyvalent alcohols. The polyvalent alcohols used may be, for example, glycols such as butyldiglycol.

In an advancement, the adhesive formulation may comprise 0.1 wt. % to 5 wt. % of an anionic or neutral wax, or a mixture of appropriate waxes.

Thereby, especially gluing chip material and/or fiber material, that is mixing with the chip material and/or fiber material, and/or the coating of chip material and/or fiber material plates can be improved. Preferably, the adhesive formulation may comprise 0.5 wt. % to 3 wt. % of an anionic or neutral wax, or a mixture of appropriate waxes. A suitable wax and/or wax mixture is, for example, the product Hydrowax 46 by Sasol.

Alternatively to one or multiple waxes as a constituent of the adhesive formulation, it is also possible for a solid wax to be added in the course of gluing the chip material and/or fiber material with the adhesive formulation, as is described in more detail below with reference to the method for producing a pressed material molded body.

In a further embodiment of the adhesive formulation, it may be provided that it comprises 0.1 wt. % to 35 wt. % of a filler or multiple fillers and/or pigment(s).

A filler and/or a pigment may ultimately influence the mechanical properties and/or a coloration of the pressed material molded body.

Moreover, it may be useful if the adhesive formulation comprises 0.1 wt. % to 6 wt. % of a wetting agent or multiple wetting agents and/or surfactants.

By this feature, particularly an improvement of the handling of the aqueous phases and an improvement of the adhesion properties of the adhesive formulation can be achieved. A suitable wetting agent is, for example, Disperbyk 190 by Byk.

Moreover, it may be provided that the adhesive formulation comprises 0.1 wt. % to 8 wt. % of a defoamer or multiple defoamers.

This feature may have an advantageous effect particularly on the pressing operation in the course of producing pressed material molded bodies, for example in order to avoid bubble formation. Surfynol 420 or Surfynol DF 75 by Evonik Corporation can be mentioned as examples for suitable defoamers.

The adhesive formulation may additionally comprise 0.1 wt. % to 8 wt. % of a thickener or multiple thickeners.

Rheolate 310 D by Element is and/or Acrysol RM 8 W by Dow are mentioned as examples for suitable thickeners. Such thickeners allow influencing the rheology and thus especially the processing properties of the two-component adhesive formulation and/or allow adapting these to requirements. In particular, adhesive formulations having a thickener are particularly suitable for producing coatings, for example by means of rolled application.

Basically, the adhesive formulation may be present as a mixed formulation comprising all contained substances, that is the aqueous phases described above of the reactive resin functionalized with hydroxyl groups or the mixture of reactive resins functionalized with functional hydroxyl groups, and the aqueous phase of the urea resin crosslinking agent and the acid catalyst as well as possible additional additives and/or ingredients. However, this may entail only a limited storability.

Hence, it may preferably be provided that the adhesive formulation comprises a first aqueous component A having the aqueous of the reactive resin functionalized with hydroxyl groups or the mixture of reactive resins functionalized with functional hydroxyl groups, and that it comprises a second component B having the aqueous phase of the urea resin crosslinking agent, wherein these components A and B are provided for forming the adhesive formulation by mixing components A and B.

In other words, the curable adhesive formulation can be formed by a mixture of the two components A and B and/or the curable adhesive formulation can be formed by mixing the two components A and B. Mixing components A and B may preferably take place directly before the application, that is directly before gluing the chip material and/or fiber material and/or before gluing the chip and/or fiber material plates, as will be discussed in more detail below.

The adhesive formulation may, for example, consist of 60 wt. % to 90 wt. % of component A and 10 wt. % to 40 wt. % of component B. In other words, the adhesive formulation can be formed by mixing 60 wt. % to 90 wt. % of component A with 10 wt. % to 40 wt. % of component B.

Here, either component A or component B may also comprise the acid catalyst. Furthermore, any possible further constituents and/or substances and/or additives, other than the specified aqueous phases and the acid catalyst, such as the additives described above, may be admixed to component A or component B. If component A and/or component B comprise further constituents, in particular additives, the person skilled in the art of course has to adapt the relevant weight proportions of components A and B. If component A and/or component B comprise further additives, it is possible that the wt. % ratio of component A to component B is to be adjusted within the framework of the wt. % ranges specified above.

The object of the invention is also achieved by a first method for producing pressed material molded bodies, in particular pressed material plates.

The method comprises the steps of
providing a chip material and/or fiber material or a chip material and/or fiber material mixture,
providing a chemically curable adhesive formulation,
mixing the chip material and/or fiber material or the chip material and/or fiber material mixture with the adhesive formulation, forming a press cake,
and continuous pressing of the press cake, while curing the adhesive formulation, or producing press cake pieces and discontinuous pressing of the press cake pieces in pressing molds, while curing the adhesive formulation.

It is essential to the method that a chemically curable, aqueous adhesive formulation as described above and defined in the relevant claims is used as the adhesive formulation. In this regard, the press cake or the press cake pieces have a weight proportion of chip material and/or fiber material or chip material and/or fiber material mixture of 77 wt. % to 98.5 wt. % and a weight proportion of adhesive formulation of 1 wt. % to 20 wt. %.

The advantages achievable by such a method with using the specified adhesive formulation have already been explained in the context of the above description of the adhesive formulation. In case of a two-component adhesive formulation being used, the appropriate two-component adhesive formulation may be formed, in the method, by combining the two components A and B. A combination and/or mixing of the two components A and B may take place before the step or also during the step of mixing the chip material and/or fiber material and/or the chip material and/or fiber material mixture with the adhesive formulation to form the press cake.

Chip material and/or fiber material and chip material and/or fiber material mixture is understood to mean a material having fibers, such as wood and/or cellulose fibers, including fibers from recycled paper, other recycling material like sawmill waste or recycled lumber, other naturally occurring fibers, such as straw, bamboo, etc., but also synthetic fibers, such as polyester fibers. The chip material and/or fiber material or the chip material and/or fiber material mixture may absolutely have different embodiments, in particular different degrees of comminution. The chip material and/or fiber material or the chip material and/or fiber material mixture may be provisioned, for example, with different grinding degrees, for example with a relatively low grinding degree as so-called chips, like in the known chipboards or OSB plates, or with relatively high grinding degree, for example, as digested, so-called wood flour, as, for example, in the known MDF and HDF plates.

In an advancement of the method, it may be provided that, while mixing the chip material and/or fiber material or the chip material and/or fiber material mixture with the adhesive formulation, 0.1 wt. % to 5 wt. % of a solid wax are admixed.

Thereby, especially gluing the chip material and/or fiber material or the chip material and/or fiber material mixture, that is mixing the adhesive formulation with the chip material and/or fiber material or the chip material and/or fiber material mixture can be improved.

Finally, the object of the invention may, however, also be achieved by a further method for producing pressed material molded bodies, in particular pressed material plates. The method comprises the steps of
providing a plurality of plates comprising chip material and/or fiber material,
coating at least one surface of the plates intended for bonding with another plate with an adhesive formulation,
layering the coated plates to form a plate layering,
pressing the plate layering in the pressing mold while curing the adhesive formulation.

It is again essential to this further method that a chemically curable adhesive formulation as described above and defined in the relevant claims is used as the adhesive formulation. A weight proportion of plates of the plate layering amounts to 80 wt. % to 99 wt. %, and a weight proportion of adhesive formulation of the plate layering amounts to 1 wt. % to 20 wt. %.

In order to better understand the invention, it is explained below in further detail by means of non-limiting exemplary embodiments, and the methods for producing pressed material plates are also explained in further detail by means of figures.

An exemplary composition of a chemically curable adhesive formulation within the context of the invention is:

### Component A:

Macrynal SC 6826 WA 42; Allnex; 73,6 wt. %,
Butyldiglycol; 5 wt. %,
Cycat 4045; Allnex, 2 wt. %
Hydrowax 46; Sasol; 1 wt. %;

### Component B:

Cymel NF 3030; Allnex; 18,4 wt. %.

In the specified exemplary embodiment, the adhesive formulation is embodied as a two-component adhesive formulation, wherein the wt. % proportions of the individual constituents of the two-component adhesive formulation refer to 100 wt. % of the two-component adhesive formulation consisting of component A and component B. In the specified exemplary embodiment, component A accordingly consists of 90.2 wt. % of Macrynal SC 6826 WA 42, 6.1 wt. % of butyldiglycol, 2.5 wt. % of Cycat 4045 and 1.2 wt. % of Hydrowax 46, based on 100 wt. % of component A. In the specified exemplary embodiment, component B consists of 100 wt. % of Cymel NF 3030. In the exemplary embodiment, the adhesive formulation is composed of 81.6 wt. % of component A and 18.4 wt. % of component B.

As already mentioned above, such a two-component embodiment of the adhesive formulation is used preferably due to an improved storability, however, an embodiment as an already mixed formulation comprising all contained substances, that is the aqueous phases described above of the reactive resin functionalized with hydroxyl groups or the mixture of reactive resins functionalized with functional hydroxyl groups, and the aqueous phase of the urea resin crosslinking agent and the acid catalyst as well as possible additional additives and/or ingredients, is generally also possible.

Macrynal SC 6826 WA 42 is an aqueous phase and/or dispersion of an acrylic polyol resin with functional hydroxyl groups, having a content of non-volatile substances of 43 wt. % and with a hydroxyl active equivalent weight (HEW) of 900 g/mol.

Cymel NF 3030 is an aqueous phase of a reaction product of ureas and multifunctional aldehydes, with a content of non-volatile substances of about 43 wt. %.

Cycat 4045 is a partially amine-blocked para-Toluenesulfonic acid catalyst.

The specified adhesive formulation has generally qualified well and universally for the known methods for producing pressed material molded bodies.

However, the specified adhesive formulation is only to be viewed as an exemplary embodiment and depending on specific requirements of a method for producing pressed material molded bodies, adapted or other formulations and/or formulas may also be used instead of the adhesive formulations indicated above.

For example, the product Macrynal SC 6826 WA 42 may be replaced by other aqueous phases of a reactive resin functionalized with hydroxyl groups or a mixture of reactive resins functionalized with functional hydroxyl groups, for example by Viacryl SC 6834 W, also by Allnex. Preferably, the reactive resin functionalized with hydroxyl groups or the mixture of reactive resins functionalized with functional hydroxyl groups may be selected from a group consisting of acrylate resins, functionalized styrene acrylate resins, functionalized acrylic acid copolymers, functionalized acrylate urethane copolymers and functionalized (meth)acrylate copolymers.

The same also applies to the further constituents of the exemplary adhesive formulation mentioned in the exemplary embodiment, that is Cymel NF 3030, butyldiglycol, Cycat 4045 and Hydrowax 46.

Products similar to those mentioned in the exemplary embodiment are generally known to the person skilled in the art. If the adhesive formulation is embodied as a two-component adhesive formulation, it also applies that any additive may likewise be admixed to component B instead of component A, as specified in the above exemplary embodiment for butyldiglycol and Hydrowax 46.

Depending on the requirements and/or procedure, it may also be useful that the adhesive formulation comprises even more additives than those specified in the above exemplary embodiment, that is butyldiglycol and Hydrowax 46. For example, the adhesive formulation may comprise, for example, 0.1 wt. % to 35 wt. % of a filler or multiple fillers and/or pigment(s), 0.1 wt. % to 6 wt. % of a wetting agent or multiple wetting agents, 0.1 wt. % to 8 wt. % of a defoamer or multiple defoamers, and/or 0.1 wt. % to 8 wt. % of a thickener or multiple thickeners. Additionally, the adhesive formulation may comprise 0.1 wt. % to 20 wt. % of a polyvalent alcohol or multiple polyvalent alcohols, as well as 0.1 wt. % to 5 wt. % of an anionic or neutral wax. As already mentioned, such additives may generally be admixed to either component A or component B in case of a two-component embodiment of the adhesive formulation.

Depending on the type and number of additives and/or depending on general requirements and the procedure of the method for producing pressed material molded bodies, the wt. % proportions of the constituents of the adhesive formulation, that is of the aqueous phases, acid catalyst(s), polyvalent alcohols as well as a variety of additives may naturally be adapted. In this regard, a respective appropriate adaption of weight proportions of the constituents can be performed by the person skilled in the art within the wt. % ranges stated above for the individual constituents. In case of an embodiment as a two-component adhesive formulation, the weight proportions of components A and B relative to one another may naturally also be adapted within the specified wt. % range.

In particular, the aqueous adhesive formulation comprises 35 wt. % to 85 wt. % of an aqueous phase of a reactive resin functionalized with functional hydroxyl groups or a mixture of reactive resins functionalized with functional hydroxyl groups with a resin content of 30 wt. % to 65 wt. %. Furthermore, the aqueous adhesive formulation comprises 12 wt. % to 25 wt. % of an aqueous phase of a urea resin crosslinking agent, which is a reaction product formed by a urea and a multifunctional aldehyde, with a resin content of 30 wt. % to 65 wt. %. The aqueous adhesive formulation additionally comprises 0.1 wt. % to 4 wt. % of an acid catalyst with a pKa value of 2 or less.

A hydroxyl active equivalent weight of the aqueous phase of the reactive resin functionalized with hydroxyl groups or the mixture of reactive resins functionalized with functional hydroxyl groups can amount to 200 g/mol to 1500 g/mol.

In the following, exemplary embodiments for methods for producing pressed material plates are described by means of figures. These show in a respectively very simplified schematic representation:

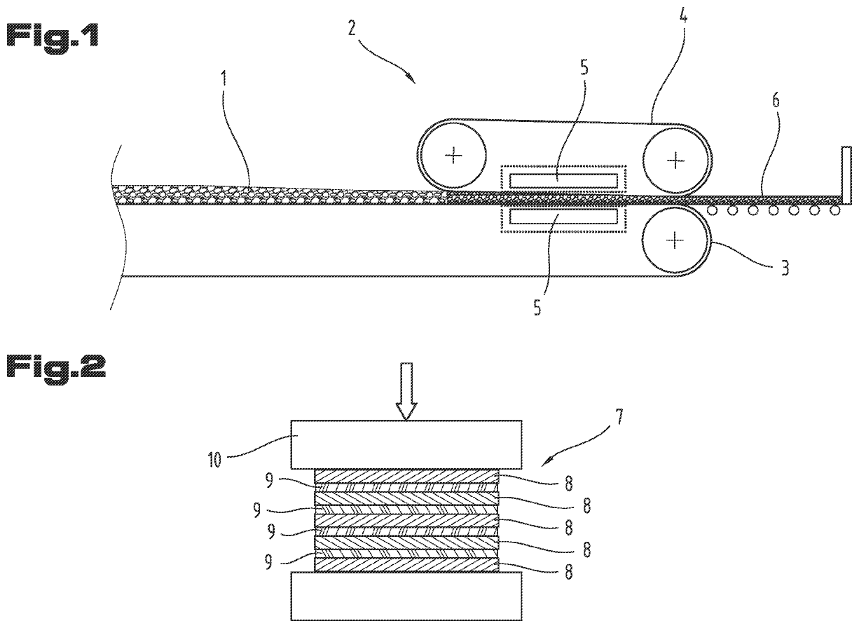

FIG. 1 an exemplary embodiment for a continuous pressing operation of a press cake to form a pressed material plate by means of a double-belt press;

FIG. 2 an exemplary embodiment for a discontinuous pressing operation for a layering of plates comprising chip material and/or fiber material and layers of the adhesive formulation.

A method for producing pressed material molded bodies, in particular pressed material plates, generally comprises the steps of
providing a chip material and/or fiber material or a chip material and/or fiber material mixture
providing a chemically curable adhesive formulation,
mixing the chip material and/or fiber material or the chip material and/or fiber material mixture with the adhesive formulation, forming a press cake,
continuous pressing of the press cake, while curing the adhesive formulation, or producing press cake pieces and discontinuous pressing of the press cake pieces in pressing molds, while curing the adhesive formulation.

In this regard, a chemically curable, aqueous adhesive formulation as described above and defined in the relevant claims may be used as the adhesive formulation.

Mixing the chip material and/or fiber material or the chip material and/or fiber material mixture with the adhesive formulation, which is also referred to as gluing in technical jargon, may be carried out in different manners, as is known per se. At this point, mechanical gluing and/or mixing in mixing devices, gluing by means of a so-called blowline, and the rarer dry gluing are mentioned as the most common methods. As these gluing and/or mixing methods are known to the person skilled in the art, an elaborate description can be done without at this point. Here, as an alternative to the exemplary embodiment for a two-component adhesive formulation mentioned above, comprising a wax (Hydrowax 46), it may be provided that, while mixing the chip material and/or fiber material or the chip material and/or fiber material mixture with the adhesive formulation, 0.1 wt. % to 5 wt. % of a solid wax are admixed.

If a two-component adhesive formulation is used for the method, the production of the adhesive formulation can be carried out by mixing components A and B, for example prior to mixing with the chip material and/or fiber material, or also while mixing with the chip material and/or fiber material.

Independently thereof, a so-called press cake is formed and/or obtained after and/or by means of mixing the chip material and/or fiber material or the chip material and/or fiber material mixture with the adhesive formulation, which press cake is subsequently subjected to pressing.

In FIG. 1, an exemplary embodiment for a continuous pressing operation for a press cake 1 is shown. Such a continuous pressing operation of the press cake 1 may be accomplished by means of a double-belt press 2 like in the exemplary embodiment shown in FIG. 1. The double-belt press 2 shown in the exemplary embodiment according to FIG. 1, has a so-called lower belt 3, on which the press cake 1 is applied and conveyed, as well as an upper belt 4 as a pressing element. The press cake 1 is guided, as illustrated in FIG. 1, between the lower belt 3 and the upper belt 4 of the double-belt press 2 and can be compressed and/or pressed by adjusting the lower belt 3 and the upper belt 4 relative to one another with a respectively desired pressure force. In the course of pressing the press cake 1, the adhesive formulation is also cured, wherein a curing of the adhesive formulation can be initiated and/or accelerated by heating, for example by means of the heating means 5 illustrated in FIG. 1.

FIG. 1 shows merely one possible exemplary embodiment for a continuous pressing of a press cake 1, wherein other, continuously working pressing systems, such as presses having press rollers or combinations of belts and rollers or so-called calenders, as it is known per se and common in this area of producing press cake molded bodies. In case of a continuous pressing, a pressed material strand 6 is obtained, as illustrated in FIG. 1, which strand 6 is subsequently separated into pressed material molded bodies, in particular pressed material plates, by means of cutting.

Alternatively to a continuous pressing, as illustrated, for example, by means of the exemplary embodiment shown in FIG. 1, it is also possible that in the method, press cake pieces previously produced in a targeted manner, which are obtainable, for example, by cutting a continuously delivered press cake, are pressed discontinuously again while curing the adhesive formulation to form a press cake molded body. Such a discontinuous pressing may be carried out, for example, in pressing molds with adjustable press stamps.

Regardless of the embodiment of the method by means of continuous or discontinuous pressing of a press cake and/or press cake piece, the press cake or the press cake pieces have a weight proportion of chip material and/or fiber material or chip material and/or fiber material mixture of 77 wt. % to 98.5 wt. % and a weight proportion of two-component adhesive formulation of 1 wt. % to 20 wt. %.

FIG. 2 shows an exemplary embodiment for an alternative method for producing pressed material molded bodies, in particular pressed material plates, in a greatly simplified and grossly schematic manner, in which method the adhesive formulation according to the invention may also be used.

This alternative method comprises the steps of
providing a plurality of plates comprising chip material and/or fiber material, in particular laminated veneer plates,
coating at least one surface of the plates intended for bonding with another plate with an adhesive formulation,
layering the coated plates to form a plate layering,
pressing the plate layering in the pressing mold while curing the adhesive formulation.

FIG. 2 shows a corresponding plate layering 7, in which plates 8 comprising chip material and/or fiber material and, in each case, one layer of the adhesive formulation 9 arranged between two plates 2 are layered alternatingly. The layering 7 illustrated in a grossly schematic manner in FIG. 7 may be pressed, for example, by means of a press stamp 10, possibly also in a pressing mold not shown in FIG. 2. Coating and/or gluing the plates 8 with the adhesive formulation 9 may take place before pressing, wherein, in principle, either one surface 11 of the plates at a time or also both surfaces 11 of at least the inner plates 8 can be coated with the adhesive formulation 9.

In the procedure by pressing plate layerings 7, illustrated in FIG. 2, it is also possible to use an adhesive formulation 9 as described above as an adhesive formulation, wherein a weight proportion of plates of the plate layering amounts to 80 wt. % to 99 wt. %, and a weight proportion of adhesive formulation of the plate layering amounts to 1 wt. % to 20 wt. %.

The exemplary embodiments show possible embodiment variants, while it should be noted at this point that the invention is not limited to these particular mentioned embodiment variants thereof.

The scope of protection is determined by the claims. Nevertheless, the description and drawings are to be used for construing the claims. Individual features or feature combinations from the different exemplary embodiments shown and described may represent independent inventive solutions. The object underlying the independent inventive solutions may be gathered from the description.

All indications regarding ranges of values in the present description are to be understood such that these also comprise random and all partial ranges from it, for example, the indication 1 to 10 is to be understood such that it comprises all partial ranges based on the lower limit 1 and the upper limit 10, i.e. all partial ranges start with a lower limit of 1 or larger and end with an upper limit of 10 or less, for example 1 through 1.7, or 3.2 through 8.1, or 5.5 through 10.

Finally, as a matter of form, it should be noted that for ease of understanding of the structure, elements are partially not depicted to scale and/or are enlarged and/or are reduced in size.

### LIST OF REFERENCE NUMBERS

1 Press cake
2 Double belt press
3 Lower belt
4 Upper belt
5 Heating means
6 Pressed material strand
7 Plate layering
8 Plate
9 Adhesive formulation
10 Press stamp

1-13. (canceled)

14. A chemically curable, aqueous adhesive formulation for producing pressed material molded bodies, in particular pressed material plates, by continuously or discontinuously pressing mixtures of the adhesive formulation and chip material and/or fiber material, or by pressing layerings of the adhesive formulation and chip material and/or fiber material plates, comprising
at least one chemically curable reactive resin and at least one crosslinking agent for the reactive resin,
wherein the aqueous adhesive formulation comprises 35 wt. % to 85 wt. % of an aqueous phase of a reactive resin functionalized with hydroxyl groups or a mixture of reactive resins functionalized with functional hydroxyl groups, with a resin content of 30 wt. % to 65 wt. %, and wherein the aqueous adhesive formulation comprises 12 wt. % to 25 wt. % of an aqueous phase of a urea resin crosslinking agent with a resin content of 30 wt. % to 65 wt. %,
wherein the urea crosslinking agent is a reaction product formed by urea and a multifunctional aldehyde, and
wherein the aqueous adhesive formulation contains 0.1 wt. % to 4 wt. % of an acid catalyst with a pKa value of 2 or less, and
wherein a hydroxyl active equivalent weight of the aqueous phase of the reactive resin functionalized with hydroxyl groups or the mixture of reactive resins functionalized with hydroxyl groups amounts to 200 g/mol to 1500 g/mol.

15. The adhesive formulation according to claim 14, wherein the reactive resin functionalized with hydroxyl groups or the mixture of reactive resins functionalized with functional hydroxyl groups is selected from a group consisting of acrylate resins, functionalized styrene acrylate resins, functionalized acrylic acid copolymers, functionalized acrylate urethane copolymers and functionalized (meth)acrylate copolymers.

16. The adhesive formulation according to claim 14, wherein the adhesive formulation comprises 0.1 wt. % to 20 wt. % of a polyvalent alcohol or multiple polyvalent alcohols.

17. The adhesive formulation according to claim 14, wherein the adhesive formulation comprises 0.1 wt. % to 5 wt. % of an anionic or neutral wax or a mixture of corresponding waxes.

18. The adhesive formulation according to claim 14, wherein the adhesive formulation comprises 0.1 wt. % to 35 wt. % of a filler or multiple fillers and/or pigment(s).

19. The adhesive formulation according to claim 14, wherein the adhesive formulation comprises 0.1 wt. % to 6 wt. % of a wetting agent or multiple wetting agents.

20. The adhesive formulation according to claim 14, wherein the adhesive formulation comprises 0.1 wt. % to 8 wt. % of a defoamer or multiple defoamers.

21. The adhesive formulation according to claim 14, wherein the adhesive formulation comprises 0.1 wt. % to 8 wt. % of a thickener or multiple thickeners.

22. The adhesive formulation according to claim 14, wherein the adhesive formulation comprises a first aqueous component A having the aqueous of the reactive resin functionalized with hydroxyl groups or the mixture of reactive resins functionalized with functional hydroxyl groups, and
wherein the adhesive formulation comprises a second component B having the aqueous phase of the urea resin crosslinking agent,
wherein components A and B are provided for forming the adhesive formulation by mixing components A and B, and
wherein the adhesive formulation comprises 60 wt. % to 90 wt. % of component A and 10 wt. % to 40 wt. % of component B.

23. A method for producing pressed material molded bodies, in particular pressed material plates, comprising the steps of
providing a chip material and/or fiber material or a chip material and/or fiber material mixture,
providing a chemically curable adhesive formulation,
mixing the chip material and/or fiber material or the chip material and/or fiber material mixture with the adhesive formulation, forming a press cake,
continuous pressing of the press cake, while curing the adhesive formulation, or producing press cake pieces and discontinuous pressing of the press cake pieces in pressing molds, while curing the adhesive formulation,
wherein the chemically curable, aqueous adhesive formulation according to claim 14 comprising at least one chemically curable reactive resin and at least one crosslinking agent for the reactive resin is used as the adhesive formulation,
wherein the aqueous adhesive formulation comprises 35 wt. % to 85 wt. % of an aqueous phase of a reactive resin functionalized with hydroxyl groups or a mixture of reactive resins functionalized with functional hydroxyl groups, with a resin content of 30 wt. % to 65 wt. %, and
wherein the aqueous adhesive formulation comprises 12 wt. % to 25 wt. % of an aqueous phase of a urea resin crosslinking agent, which is a reaction product formed by urea and a multifunctional aldehyde, with a resin content of 30 wt. % to 65 wt. %, and
wherein the aqueous adhesive formulation comprises 0.1 wt. % to 4 wt. % of an acid catalyst with a pKa value of 2 or less, and
wherein the press cake or the press cake pieces have a weight proportion of chip material and/or fiber material or chip material and/or fiber material mixture of 77 wt. % to 98.5 wt. % and a weight proportion of adhesive formulation of 1 wt. % to 20 wt. %.

24. The method according to claim 22, wherein, while mixing the chip material and/or fiber material or the chip material and/or fiber material mixture with the adhesive formulation, 0.1 wt. % to 5 wt. % of a solid wax are admixed.

25. A method for producing pressed material plates, comprising the steps of
providing a plurality of plates comprising chip material and/or fiber material,
coating at least one side of the plates intended for bonding with another plate with an adhesive formulation,
layering the coated plates to form a plate layering,
pressing the plate layering in the pressing mold while curing the adhesive formulation,
wherein the chemically curable, aqueous two-component adhesive formulation according to claim 14 comprising at least one chemically curable reactive resin and at least one crosslinking agent for the reactive resin is used as the adhesive formulation,
wherein the aqueous adhesive formulation comprises 35 wt. % to 85 wt. % of an aqueous phase of a reactive resin functionalized with hydroxyl groups or a mixture of reactive resins functionalized with functional hydroxyl groups, with a resin content of 30 wt. % to 65 wt. %, and
wherein the aqueous adhesive formulation comprises 12 wt. % to 25 wt. % of an aqueous phase of a urea resin crosslinking agent, which is a reaction product formed by urea and a multifunctional aldehyde, with a resin content of 30 wt. % to 65 wt. %, and
wherein the aqueous adhesive formulation comprises 0.1 wt. % to 4 wt. % of an acid catalyst with a pKa value of 2 or less, and
wherein a weight proportion of plates of the plate layering amounts to 80 wt. % to 99 wt. %, and a weight proportion of adhesive formulation of the plate layering amounts to 1 wt. % to 20 wt. %.
